(19) United States
(12) Patent Application Publication
(10) Pub. No.: US 2012/0097046 A1
(43) Pub. Date: Apr. 26, 2012

(54) Kabob cooker and grill

(76) Inventors: Edward Michael Jones, Stratford, CT (US); Zhengqing Yang, Guang Zhou (CN); Po Kong Lok, Hongkong (CN); Kong Wong, Hongkong (CN)

(21) Appl. No.: 12/998,419

(22) PCT Filed: Nov. 4, 2009
(86) PCT No.: PCT/US09/05965

§ 371 Date: Nov. 10, 2011

Related U.S. Application Data
(60) Provisional application No. 61/198,383, filed on Nov. 6, 2008.

(51) Int. Cl. A47J 37/04

(52) U.S. Cl. 99/334

(57) ABSTRACT

An automatic kabob cooker and grill that utilizes a motor to automatically rotate a plurality of skewers to cook food in a kabob style manner indoors or outdoors. The disclosed invention utilizes a heating element which is located above the skewers and below a grill plate. The heating element serves to cook food of the rotating skewers as well as to heat the surface of a grill plate that is used to cook foods other than foods cooked on the skewers. Grill plate for the purpose of present invention is reversible with ribs on one side for grilling and flat on the other side for griddle capabilities. The present invention has cylindrical devices that can be temporarily attached to said skewers which provide a rotating rolling surface for grilling hot dogs and like foods.

### TECHNICAL FIELD

### U.S. Patent Documents

| | | |
|---|---|---|
| U.S. Pat. No. 1,206,527 | June 1911 | Giovanna |
| U.S. Pat. No. 2,335,217 | May 1941 | Tate |
| U.S. Pat. No. 2,831,954 | April 1958 | Pirz |
| U.S. Pat. No. 3,442,202 | May 1969 | Ishida |
| U.S. Pat. No. 4,154,154 | May 1979 | Vivian |
| U.S. Pat. No. 5,001,971 | March 1991 | Beller |
| U.S. Pat. No. 5,172,628 | December 1992 | Pillsbury |
| U.S. Pat. No. 5,960,706 | October 1999 | Cheng |
| U.S. Pat. No. 6,131,505 | October 2000 | Lin |
| U.S. Pat. No. 6,546,845 B1 | April 2003 | Lanzilli |
| U.S. Pat. No. 6,965,095 B1 | November 2005 | Popeil/Backus |
| U.S. Pat. No. 7,012,204 B2 | April 2006 | Popeil/Backus |
| U.S. Pat. No. 7,220,945 B1 | May 2007 | Wang |
| US2009/0000493 A1 | January 2009 | Mosher |

### BACKGROUND OF ART

The present invention relates to an electric cooking appliance and in particular a method and mode of cooking various types of kabobs indoors. The present invention has a reversible grill and griddle plate that is utilized for cooking foods in addition to foods cooked on kabob skewers. An electric heating element is strategically mounted to the housing frame to provide optimum heat to both the kabob skewers and the grill plate.

There are several patents pertaining to kabob cooking. For example, U.S. Pat. No. 1,206,527 to Giovanna discloses a rotisserie single spit oven that can be operated by hand or motor and is part of a range. The heating source is a combustion stove. The present invention is clearly different and an improvement since present invention uses a plurality of skewered kabobs for cooking as opposed to a single spit and present invention is portable which can be used on a countertop with its own heating element and grill and griddle.

U.S. Pat. No. 2,335,217 to Tate discloses a portable indoor or outdoor grill with rotisserie although it claims a heat source as charcoal. It utilizes a hand cranked single spit or skewer. The present invention is an improvement since it uses an electric heating element more suited indoor use and incorporates multiple skewers for kabobs rotated by an electric motor.

U.S. Pat. No. 2,831,954 to Pirz discloses a single spit or skewer rotisserie which is hand cranked and enclosed within an oven which obtains it heat for cooking from electrical resistance elements. In contrast the present invention utilizes a motor that rotates a plurality of skewers and has a grill and griddle plate for cooking other plate foods.

U.S. Pat. No. 5,001,971 to Beller discloses a shish kabob rotisserie in which it utilizes a motor to rotate a series of skewers which is chain driven. It is intended only to be used outdoors over an outdoor grill fire box. It also disclosed unique skewers that have fork like spring loaded tines. The present invention is distinctly different and an improvement since it has its own electric heat source for cooking food and it is intended to be used indoors. The present invention is also gear and chain driven. Utilization of a chain for rotation of food in the cooking process is not new and can also be seen in U.S. Pat. No. 4,403,595 Maesk discloses the use of a chain to rotate cooking food. The present invention is differs and is an improvement over the aforementioned patents in that it uses a series of gears emanating from the motor and transferring power from the housing to the gear in the skewer holder which rotates the chain and converts power to a gear at the opposite end which in turn transfers power into another kabob holder by means of a gear. The present invention has a reversible grill and griddle that sets on top of the heating element which gives the present invention an alternative method of cooking food such as grilling a steak or cooking bacon which the aforementioned patent cannot accomplish.

U.S. Pat. No. 5,171,628 to Pillsbury, U.S. Pat. No. 3,442,202, to Ishida U.S. Pat. No. 4,154,154 to Vivian U.S. Pat. No. 5,960,706 to Cheng all disclose devices that utilize a motor for rotating skewers but use a distinctly separate heating source not part of the invention such as an outside grill. The present utilizes a built-in heating unit as an integral part of said invention for cooking thereby making it easier to use and more convenient.

U.S. Pat. No. 6,131,505 to Lin discloses a electric grill and motorized rotisserie wherein you have to disconnect one to run the other therefore you cannot rotisserie and grill at the same time. The aforementioned invention is a single spit rotisserie only not useable for a plurality of skewer kabobs. With the present invention allows you cook a plurality of skewered kabobs while utilizing the grill or griddle at the same time.

### DISCLOSURE OF INVENTION

The present invention is a portable kabob cooker and grill comprised of a housing frame that utilizes an electric heating element as a heat supply for cooking food and is an integral part of the invention. The heating element serves a two-fold purpose; it radiates heat downward to cook skewered kabobs and heats the grill plate located directly above it for cooking a variety of foods that may or may not be suitable for cooking on a skewer.

A motor is used for the rotation of the skewered kabobs and said motor is located in an end panel which is one of two end panels that constitute key structures of the housing frame. The motor turns a master gear that meshes with a gear located within a skewer holder which has a series of gears and sprockets that subsequently turns a drive chain which in turn rotates the skewers that have sprockets mounted to them and interface with drive chain. The skewer holders are supported by the bottom heat shield which is a structural component of the housing frame and skewer holders slide in and out beneath the heating element. Their easy removal makes for convenient loading and unloading of skewered kabobs and for easy cleaning of skewer holders and removable drip pans that rest on the bottom plate of the skewer holder and directly beneath the kabobs to catch drippings.

The present invention has incorporated a reversible grill and griddle plate to add versatility to the cooking function of said invention. One side of the grill plate has ribs for grilling food such a steaks and chicken breast which are larger than what is normally cooked on skewers. The opposite side of the grill plate features a flat surface for cooking bacon and other type foods not normally cooked on skewers. Present invention may have a single side grill plate which could be a smooth surface or could be a ribbed surface or a combination of both surfaces on one side. The cooking of kabobs and the use of the grill plate can be accomplished at the same time from the same heat source.

Other structural components, features, and advantages of the present invention are available and disclosed throughout the description of drawings and preferred embodiments.

### BRIEF DESCRIPTION OF DRAWINGS

FIG. 1 a perspective view of the kabob cooker and grill from the front location with skewer holders and grill plate in place;

FIG. 2 a perspective view of the kabob cooker and grill from left side with grease cup in place and removed from end panel and free standing

FIG. 3 a perspective view of the kabob cooker and grill front view with cut-away of motor, transmission, and master gear, kabob holder gear and chain;

FIG. 4 a perspective view of the kabob cooker and grill from the top without the grill plate in place;

FIG. 5 a perspective view of the kabob cooker and grill of skewer holders with cut-away gear, drive chain system and sprocket meshing with drive chain;

FIG. 6 a perspective view of the kabob cooker and grill of grill plate depicting the ribbed side and the flat side;

FIG. 7 a perspective view of the kabob cooker and grill of skewer and its improved design to hold food and cylindrical device on said skewer securely;

FIG. 7A a perspective view of the kabob cooker and grill illustrates the cylindrical rollers for cooking food such as hot dogs;

FIG. 8 a perspective view of the kabob cooker and grill kabob holder and drip pans

FIG. 9 a perspective view of the kabob cooker and grill from the back depicting the removable back panel and its holders;

### BEST MODE FOR CARRYING OUT THE INVENTION

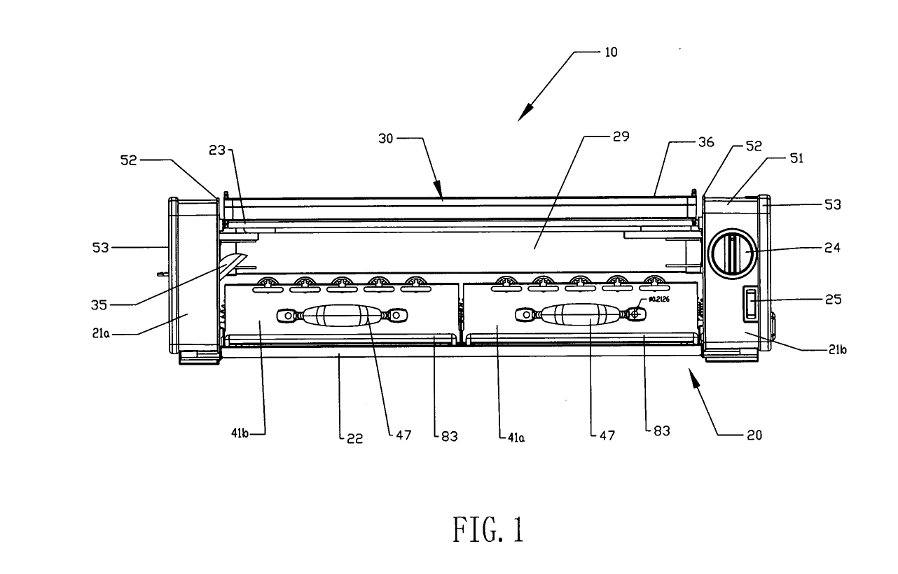

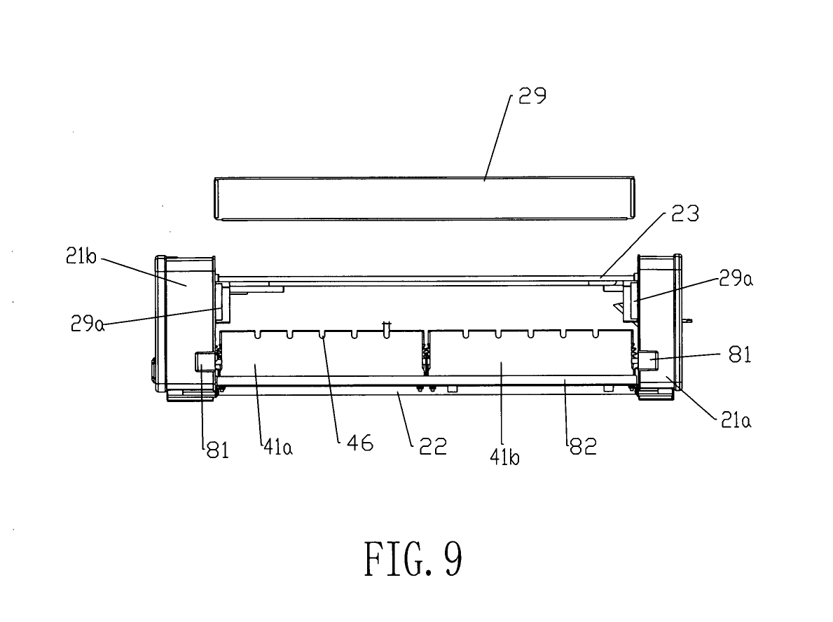

With reference to the drawings and in accordance to the present invention which is illustrated in FIG. 1 the kabob cooker and grill and generally referenced at 10 hereinafter referred to as kabob grill. Kabob grill 10 includes a frame 20 which generally includes a left end panel 21a and a right end panel 21b a bottom support plate 22 and grill plate supports 23. As best shown in FIG. 9 back end panel 29 is removable for cleaning and slides in and out of back panel brackets 29a.

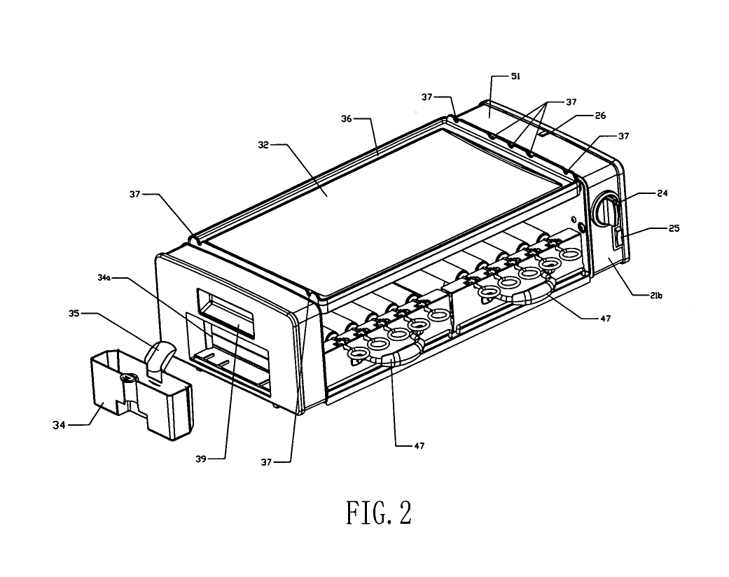

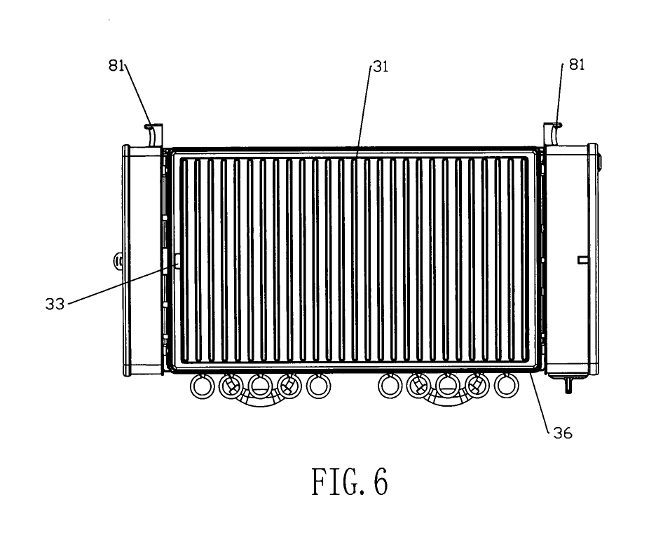

Grill plate 30 rests on grill plate supports 23 and may have one or two cooking surfaces as depicted in FIG. 2 and FIG. 6 wherein 32 depicts a smooth griddle surface for cooking eggs and like foods and 31 depicts a ribbed surface which is better suited for grilling items like steaks. However, as previously stated, the grill plate may have only one surface. Grill Plate 30 as shown in FIG. 6 has a hole in its surface 33 which allows food drippings to exit the grill plate and collect in a grease cup 34 of FIG. 2. Grease cup 34 is removable for cleaning and is housed in left end panel 21a. Grease cup 34 has a spout 35 that extends up and through left end panel 21a and rests immediately below grill plate hole 33 which can be best seen in FIG. 1. Grill plate 30 has raised edges 36 around its perimeter to prevent liquids from flowing off the edge of grill plate. Grill plate 30 has notches 37 in its raised edges 36 which allow it to rest securely in grill plate supports 23.

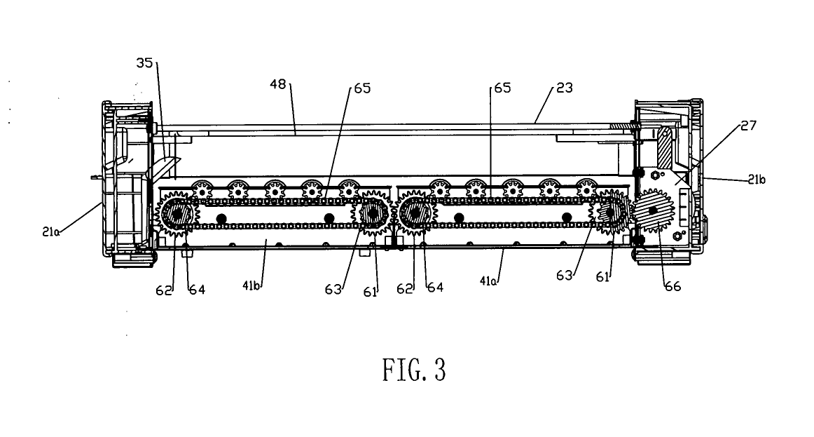

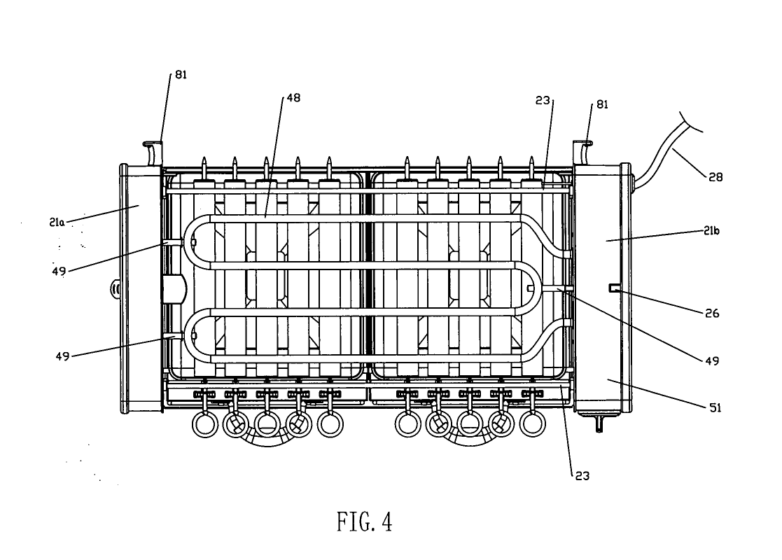

As best shown in FIG. 1, FIG. 3, and FIG. 4 right end panel 21b houses a thermostat 24 which is used to regulate the temperature of the heating element, motor 27 that turns the kabobs, an motor on-off switch 25 that energizes motor and de-energizes said motor, and an indicator light that signals that the thermostat is activated. Power cord 28 emanates from said end panel and is power supply to the kabob grill 10. FIG. 2 depicts the right end panel which has a steel shroud 51 that encloses and protects motor, thermostat, switches and wiring. FIG. 1 depicts interior wall heat shields 52 that provide hear defection away from end panels which houses said wiring, and controls. End caps 53 are depicted in FIG. 1 and FIG. 2. End caps enclose end panels 21a and 21b and have handles 39 built in for lifting and moving kabob grill 10.

As best shown in FIG. 2 left end panel 21a best depicts handle 39. Also shown in FIG. 2 is grease cup housing 34a area in which grease cup 34 sits.

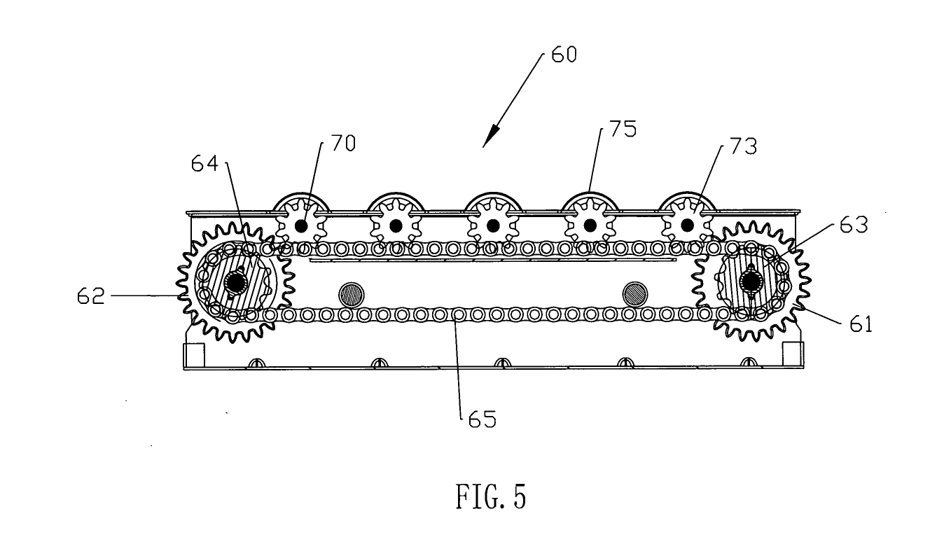

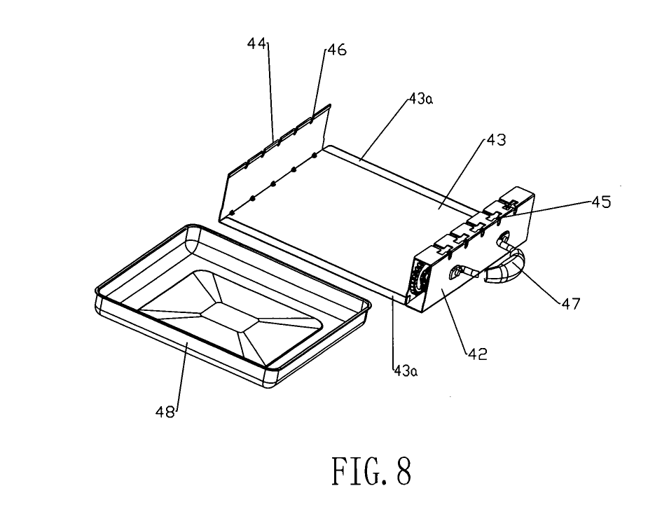

As best shown in FIG. 8 the skewer holder 40 consists of a front panel 42, bottom panel 43 with raised side edges 43a, and a back panel 44. Front panel 42 houses skewer holder gear and chain mechanism 60 of FIG. 5. There are skewer slots FIGS. 8, 45 and 46 located at the top front panel 42 and on the back panel 44 wherein skewers sit and are allowed to rotate. A handle 47 is used for the purpose of inserting and removing skewer holder 40. A drip pan 48 sits in skewer holder 40 and whose purpose is to catch food drippings. Drip pan 48 is removable for cleaning.

Referring to FIG. 5 and as previously mentioned skewer holder gear and chain mechanism 60 is comprised of two gears 61 and 62 which rotate two sprockets 63 and 64 to which a drive chain 65 is attached to said sprockets and which subsequently rotates skewers via skewer sprockets 73. As best shown in FIG. 3 master gear 66 which is directly connected and rotated by motor 27, meshes with gear 61 located in skewer holder 41a when it is placed into position in frame 20. Gear 61 rotates attached sprocket 63 which rotates drive chain 65 which rotates skewer 70. Drive chain 65 rotates sprocket 64 which is attached to gear 62 which in turn rotates gear 61 located in kabob holder 41b likewise rotates sprocket 63 whereby rotating drive chain 65 which rotates sprocket 64 which rotates gear 62 and the same sequence could continue with several addition kabob holders 40 in a larger frame 20.

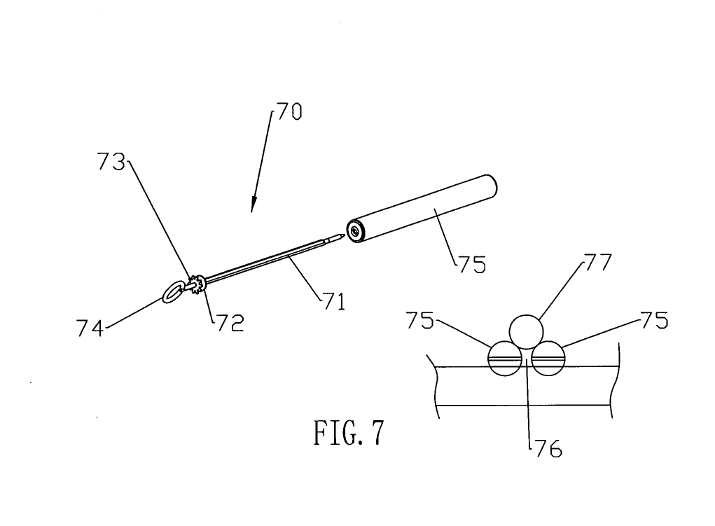

As best shown in FIG. 7 kabob skewer 70 has a rectangular shape 71 to better hold food in place when said food is mounted to skewer and to lock cylindrical device 75 in place. A flat circular plate 72 is mounted to skewer which serves as a stop plate from sliding food too far onto skewer 70 which thereby could interfere with proper kabob operation. A skewer handle 74 is attached to end of skewer 70 which is used for lifting and moving said skewer 70. A sprocket 73 is mounted to skewer 70. Skewer sprocket 73 interlocks with aforementioned drive chain 65 when said skewer is placed in kabob holder slots FIGS. 8, 45 and 46. When skewer sprocket 73 is placed into position into skewer holder and interlocks with drive chain 65 said skewers 70 are rotated when motor 27 is energized by motor on-off switch 25 which starts the process of motor 27 to rotate master gear 66 which meshes with gear 61 that rotates sprocket 63 that rotates drive chain 65 that rotates skewer 70. The skewer holder 40 can hold a plurality of skewers all of which rotate below heating element 48 as best shown in FIG. 4 which is strategically designed and located for maximum coverage and heat distribution to skewers 70 and grill plate 30. Motor 27 turns at a slow rotation thereby rotating skewers at a slow rate for optimal cooking efficiency without burning food on skewers 70 while cooking them in an optimal time.

Referring to FIG. 7, cylindrical device 75 is mounted to skewer 70 and locked into place by a slight turn of the cylinder. It is then placed onto kabob holder 40 whereby skewer 70 is placed into skewer holder slot 45 and 46 and skewer sprocket 73 interlocks with drive chain 65 which rotates cylindrical device 75 when motor 27 is activated and begins the rotational process. The purpose of the cylindrical device 75 is to have two or more cylindrical devices mounted on the skewer holder 40 and situated adjacent to one another FIG. 7A thereby creating a crevice in which a hot dog or sausage 77 or similar type food can sit and rotate in same position when motor 27 is activated. The purpose of said rotation of hot dog or sausage 77 below the heating element 48 is to reduce chance of burning said food.

As best shown in FIG. 9 removable back panel 29 is inserted in holders 29a. Said removable back panel 29 purpose is to enhance cooking time by retaining heat within the cavity between the heating element 48 and the skewer holder 40. Another purpose of removable back panel 29 is to reduce spattering that could be a result of food cooking on skewers 70.

The aforementioned heating element 48 as best shown in FIG. 4 is supported by horizontal struts 49 emanating from end panels 21a and 21b. Thermostat 24 is connected to heating element 48 and monitors and controls the heating element output.

As best shown in FIG. 4 and FIG. 6 stand-offs 81 prevent kabob cooker and grill 10 from being slid up against a wall thereby protecting wall from heat or spattering grease. Referring to FIG. 9 the aforementioned bottom plate 22 has a raised edge 82 at the rear of the bottom plate that acts as a stop for the skewer holder 40 when it is placed into frame 20. As shown in FIG. 1 there are guard rails to hold skewer holders 40 in place and to prevent them from sliding out of position which thereby disengage gear 61 from master gear 66.

What is claimed is:

1. A kabob cooker and grill comprising:
a motor to automatically rotate a plurality of skewers that sit atop skewer holders and are rotated by a series gears and a chain located within the said skewer holders.
a frame which supports a grill plate and skewer holders and houses a motor and controls.
a grill plate that sits above said electric heating element and which for the purposes of the present invention is shown as a reversible grill plate but it may also utilize a single use side grill plate only.
an electric heating element which constitutes an integral part of said invention located directly above the skewer holders and directly below grill plate transferring heat in an upward direction towards said grill plate and a downward direction towards said skewers.
a plurality of drum type cylindrical devices that temporarily slide over said skewers

2. A kabob cooker and grill of claim 1 wherein said frame has end panels of which one said end panel houses a motor, a master gear, electrical controls and wiring and the other end panel houses a grease cup.

3. A kabob cooker and grill of claim 2 wherein said end panels are comprised of an interior wall heat shield plate, a metal plate which wraps around the front, top and back of said end panels and has end caps with built-in handles.

4. A kabob cooker and grill of claim 1 wherein said skewer holders are constructed of a front panel, back panel, side panels and bottom plate.

5. A kabob cooker and grill of claim 1 wherein said motor, when energized, rotates a master gear that extends out from said interior wall heat shield plate of said end panel and interlocks with a gear extending out from skewer holder front panel which subsequently rotates said skewers through a series of synchronized gears and drive chain located in skewer holder front panel.

6. A kabob cooker and grill of claim 2 wherein said skewer holders rest adjacent to one another on housing bottom heat shield and are connected via intermeshing gears which transfers rotation from one skewer holder to the next.

7. A kabob cooker and grill of claim 1 wherein said skewers have sprockets attached to the skewer shaft and interconnect with said gears in skewer holder front panel and pointed end of skewer end rests on skewer holder back panel.

8. A kabob cooker and grill of claim 1 wherein said skewers shafts have been. designed to be slightly flattened and rectangular for improved food security during rotation.

9. A kabob cooker and grill of claims 1 and 6 wherein said skewer holders have a plurality of openings in said skewer holder front panel in which said skewer sprocket sit and mesh with gears located within the front panel of said skewer holder thereby rotating skewers when motor is energized.

10. A kabob cooker and grill of claim 5 wherein gears are synchronized to turn skewers in same direction which is needed for cooking hot dogs and like food when cylindrical devices are temporarily attached to skewers.

11. A kabob cooker and grill of claim 1 wherein said reversible grill plate has a grease drain hole located on its surface to provide a means of discarding unwanted oil, grease and other liquids while cooking.

12. A kabob cooker and grill of claim 2 wherein one said end panel houses said grease cup to catch drippings from said grill plate grease drain hole.

13. A kabob cooker and grill of claim 1 wherein said reversible grill plate has a ribbed surface on one side and a smooth griddle type surface on the opposite side.

14. A kabob cooker and grill of claim 12 wherein said reversible grill is supported by said metal tie rods that are positioned slightly above heating element

15. A kabob cooker and grill of claim 12 wherein said grease cup has a funnel type extension connected to the top of said grease cup which extends upwardly through interior end panel wall heat shield to said grill plate drain hole.

16. A kabob cooker and grill of claim 12 wherein said grease cup is removable for emptying and cleaning

17. A kabob cooker and grill of claims 1 and 10 wherein a plurality of cylindrical devices and are the approximate length of interior skewer holder from front to back mounted in parallel to a corresponding quantity of skewers and rotate when said motor is energized.

18. A kabob cooker and grill of claim 17 wherein the cylindrical devices are mounted on skewers they slowly rotate to cook hot dogs, sausage and like foods thereby cooking all sides of said food and minimizing burning of said food.

19. A kabob cooker and grill of claim 4 where in skewer holders have drip pans that rest on skewer bottom plate and catch drippings from kabobs and are removable.

20. A kabob cooker and grill of claim 1 wherein removable back panel is inserted in slots which are attached to the interior back section of the end panels heat shield and acts as a heat escape barrier which keeps more heat in and around the kabobs which speeds up the cooking process.

21. A kabob cooker and grill of claim 1 wherein said heating element is designed and positioned so the heat it radiates provides the maximum exposure to both the kabobs and the grill plate.

22. A kabob cooker and grill of claim 1 wherein said heating element is attached to the interior wall heat shield plate and is supported by horizontal struts that extend from the interior walls.

23. A kabob cooker and grill of claim 1 wherein said heating element is controlled by thermostat located on said end panel and when said thermostat is activated a power on light is illuminated.

24. A kabob cooker and grill of claim 1 wherein said motor is controlled by a switch control located on said end panel.

25. A kabob cooker and grill of claim 11 wherein said grill plate is removable for cleaning in a sink or dishwasher.

26. A kabob cooker and grill of claim 1 wherein said grill plate has a bow in its cooking surface to help prevent warping of grill plate.
